(19) United States
(12) Patent Application Publication
(10) Pub. No.: US 2025/0104526 A1
(43) Pub. Date: Mar. 27, 2025

(54) GAMING DEVICE WITH PERSISTENCE SYMBOL CHANGING

(71) Applicant: Aristocrat Technologies, Inc., Las Vegas, NV (US)

(72) Inventors: Kelly Lockheed, Elkridge, MD (US); Jennifer Mizzi, Ewa Beach, HI (US); Rogelio Decasa, JR., Renton, WA (US); Nathan Warms, Austin, TX (US); Zachary Smith, Austin, TX (US); Erick Ching, Cedar Park, TX (US); Scott Hopkins, Austin, TX (US); Hanna Sanborn, Georgetown, TX (US); Carlyn Albright, Reno, NV (US); Zachary Cohen, Chicago, IL (US)

(21) Appl. No.: 18/474,057

(22) Filed: Sep. 25, 2023

(51) Int. Cl. G07F 17/32

(52) U.S. Cl. CPC G07F 17/3267; G07F 17/3213; G07F 17/3269

(57) ABSTRACT

A gaming system includes a processor and a memory storing instructions and a persistence counter. The instructions cause the processor to cause display of an initial game outcome by displaying symbols from a plurality of reels in a plurality of columns, the plurality of reels including a plurality of symbol types and increment the persistence counter based on the initial game outcome. The instructions further cause the processor to determine, based on a value of the persistence counter, at least one symbol type of the plurality of symbol types, change the at least one symbol type in the initial game outcome to a second symbol type, and determine, based on changing the at least one symbol type, an upgraded game outcome.

### TECHNICAL FIELD

The field of disclosure relates generally to electronic gaming, and more specifically, to electronic gaming operations and devices that provide a persistence feature during game play that causes a changing of outcome symbols.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

### BRIEF DESCRIPTION

In one aspect, a gaming system is provided. The gaming system includes a processor and a memory storing instructions and a persistence counter. The instructions cause the processor to cause display of an initial game outcome by displaying symbols from a plurality of reels in a plurality of columns, the plurality of reels including a plurality of symbol types and increment the persistence counter based on the initial game outcome. The instructions further cause the processor to determine, based on a value of the persistence counter, at least one symbol type of the plurality of symbol types, change the at least one symbol type in the initial game outcome to a second symbol type, and determine, based on changing the at least one symbol type, an upgraded game outcome.

In another aspect, a non-transitory computer-readable media is provided. The media contains instructions embodied thereon which, when executed by a processor, cause the processor to cause display of an initial game outcome by displaying symbols from a plurality of reels in a plurality of columns, the plurality of reels including a plurality of symbol types and increment a persistence counter based on the initial game outcome. The instructions further cause the processor to determine, based on a value of the persistence counter, at least one symbol type of the plurality of symbol types, change the at least one symbol type in the initial game outcome to a second symbol type, and determine, based on changing the at least one symbol type, an upgraded game outcome.

In yet another aspect, a method of implementing a game is provided. The method includes causing display of an initial game outcome by displaying symbols from a plurality of reels in a plurality of columns, the plurality of reels including a plurality of symbol types and incrementing a persistence counter based on the initial game outcome. The method further includes determining, based on a value of the persistence counter, at least one symbol type of the plurality of symbol types, changing the at least one symbol type in the initial game outcome to a second symbol type, and determining, based on changing the at least one symbol type, an upgraded game outcome.

### BRIEF DESCRIPTION OF THE DRAWINGS

FIG. 1 is an exemplary diagram showing several gaming machines networked with various gaming related servers.

FIG. 2A is a block diagram showing various functional elements of an exemplary gaming machine.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIG. 4 is a schematic illustrating a memory storing data files for use with a gaming device, such as a gaming device similar to the gaming device of FIG. 1.

FIG. 5 is a flow chart of a process for executing electronic game play for display to a user using the contents of the memory of FIG. 4.

FIG. 6 is an example screen display showing display of a first instance of a game according to the process of FIG. 5.

FIG. 7 is an example screen display showing display of another game instance of the game shown in FIG. 6, in which an upgrade feature of the game is triggered.

FIG. 8A is an example screen display showing an initial outcome of the game instance shown in FIG. 7, prior to changing the symbols according to the upgrade feature.

FIG. 8B is an example screen display showing a final outcome of the game instance shown in FIG. 7, after changing the symbols according to the upgrade feature.

FIG. 9A is an example screen display showing an initial outcome of a game instance of the upgrade feature shown in FIG. 8A, prior to changing the symbols according to the upgrade feature.

FIG. 9B is an example screen display showing a final outcome of the game instance shown in FIG. 9A.

FIG. 10A is an example screen display showing display of a first instance of another upgrade feature of the game according to data files stored on the memory of FIG. 4.

FIG. 10B is an example screen display showing display of the first instance of the upgrade feature, shown in FIG. 10A, showing a persistence meter being incremented.

FIG. 11A is an example screen display showing display of the first instance the upgrade feature, shown in FIG. 10A, prior to changing the symbols according to the upgrade feature.

FIG. 11B is an example screen display showing a final outcome of the game instance shown in FIG. 11A.

FIG. 12A is an example screen display showing display of another instance the upgrade feature, shown in FIG. 10A, prior to changing the symbols according to the upgrade feature.

FIG. 12B is an example screen display showing a final outcome of the game instance shown in FIG. 12A.

FIG. 13A is an example screen display showing display of another instance the upgrade feature, shown in FIG. 10A, prior to changing the symbols according to the upgrade feature.

FIG. 13B is an example screen display showing a final outcome of the game instance shown in FIG. 13A.

### DETAILED DESCRIPTION

Described herein are systems and methods for providing a persistence feature during game play that causes a changing of outcome symbols in electronic gaming. In the embodiments described herein, an electronic game is provided that includes a plurality of reels provided within a plurality of symbol positions. During play of the base game, scatter symbols occurring in the outcome are persistently stored and increment a persistence meter. During game play, an upgrade feature may be activated which changes symbol types in the outcome to a different and optionally a single symbol type, thereby increasing the likelihood of winning combinations in the outcomes. The symbol types that are changed may be based on the value of the persistence meter when the upgrade feature is triggered. As more scatter symbols are accumulated during play of the base game, a greater number of symbol types that will be changed in the feature are unlocked and displayed to the player.

The technical problems addressed herein include: (i) inability of known systems to provide persistence features during game play that cause a changing of outcome symbols; (ii) inability of known systems to provide display variance in accumulating different symbols eligible to be changed in the feature based on play of the base game; (iii) inability of known systems to maintain a controlled and/or consistent likelihood of triggering a feature or upgraded payouts of the feature; (iv) inefficient use of computer resources in known gaming systems at least because of burdensome processing requirements when determining award enhancements to be applied in an feature; and (v) lack of processing availability and speed in known gaming systems at least because of the burdensome processing requirements.

The resulting technical effect and/or technical benefits achieved herein include at least one of: (i) ability to provide persistence features during game play that causes a changing of outcome symbols; (ii) ability to provide display variance in accumulating different symbols eligible to be changed in the feature based on play of the base game; (iii) ability to maintain a controlled and/or consistent likelihood of triggering a feature or upgraded payouts of the feature; (iv) improved efficiency in the use of computer resources by determining award enhancements to be provided in the upgraded feature based on persistent collectable scatter symbols collected during play of the base game; and (vi) improved processing availability and speed at least because of the improved efficiency in the use of computer resources.

The description provided herein includes certain examples and exemplary use cases. It should be understood that these examples and use cases are included herein for illustrative purposes, and these examples and use cases should not be taken to limit the present disclosure. The systems and methods described herein may be used in many other use cases.

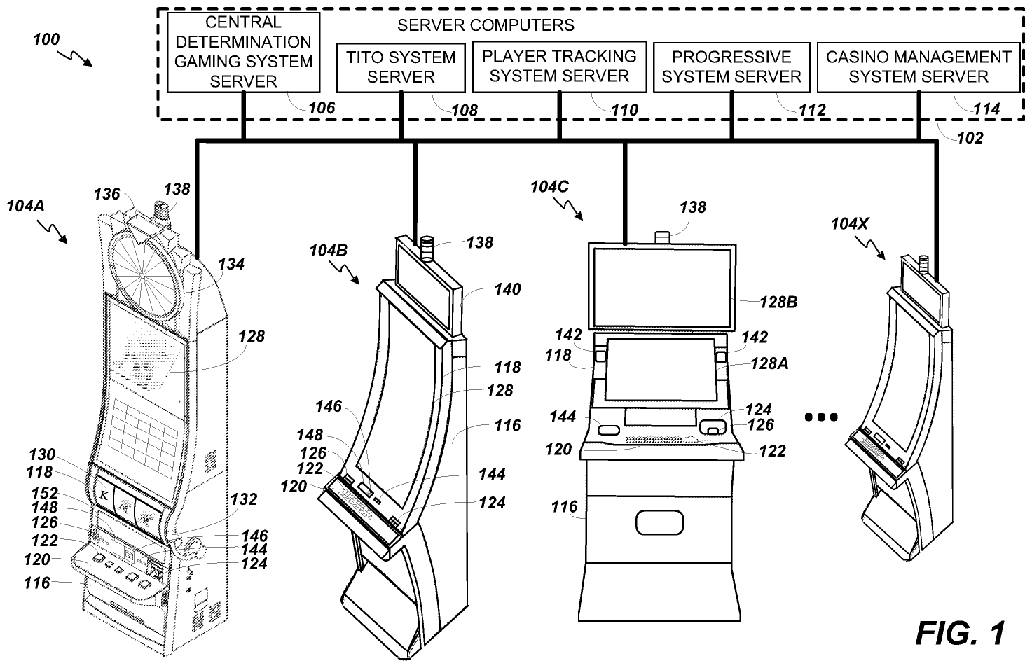

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementation, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed.

Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

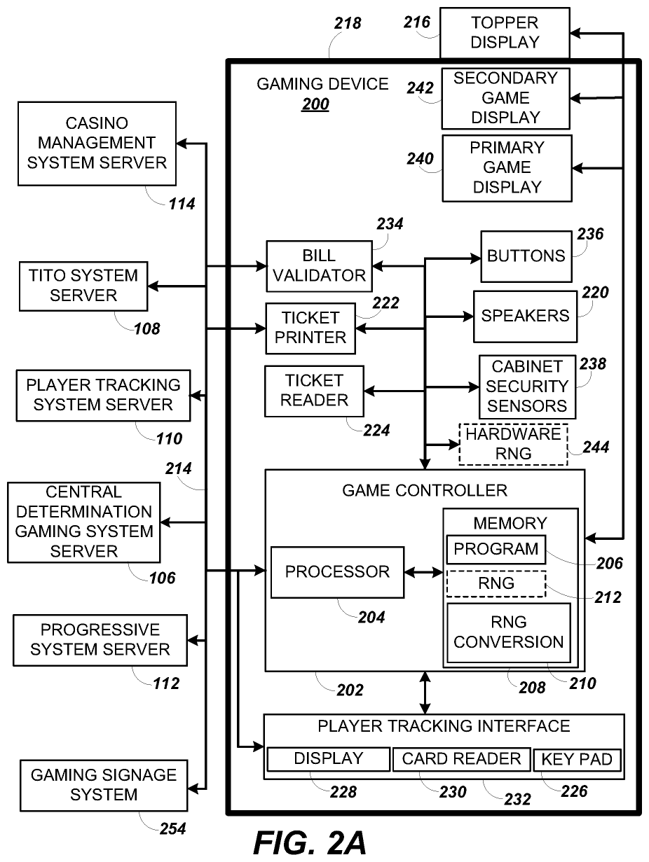

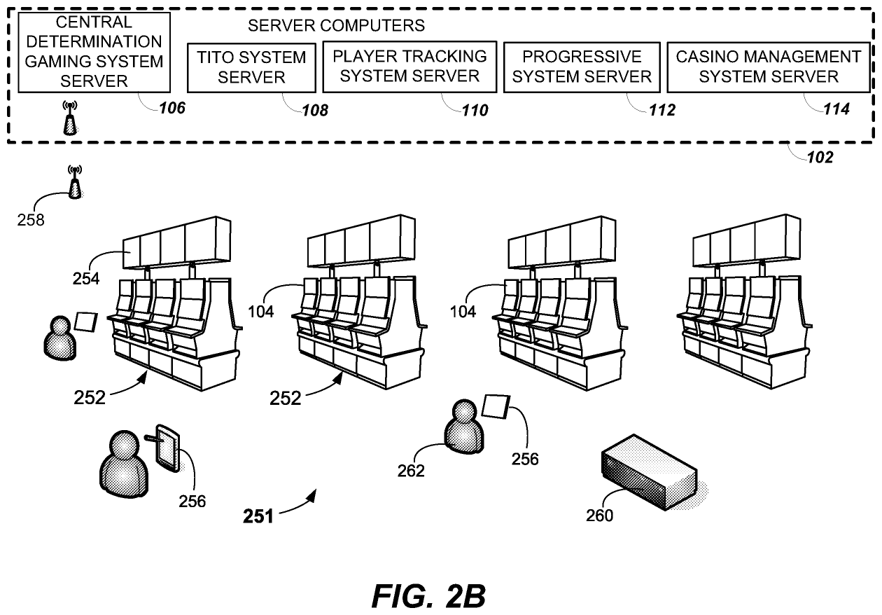

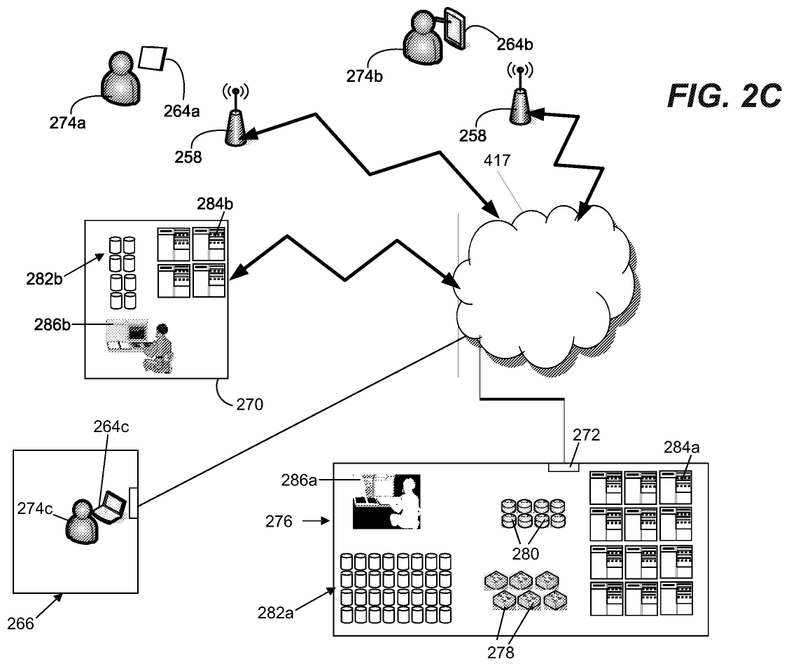

Many or all the above described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play or any other information or media desired by the game designer or operator. In some implementations, example gaming device 104C may also include speakers 142 to output various audio such as game sound, background music, etc.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 408. Memory 408 is defined herein as including volatile and nonvolatile memory and other types of non-transitory data storage components. Volatile memory is memory that do not retain data values upon loss of power. Nonvolatile memory is memory that do retain data upon a loss of power. Examples of memory 408 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 408, game controller 202 could include multiple memories 208 for storing program instructions and/or data.

Memory 408 can store one or more game programs 206 that provide program instructions and/or data for carrying out various implementations (e.g., game mechanics) described herein. Stated another way, game program 206 represents an executable program stored in any portion or component of memory 408. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 408 and run by processor 204; (2) source code that may be expressed in proper format such as object code that is capable of being loaded into a random access portion of memory 408 and executed by processor 204; and (3) source code that may be interpreted by another executable program to generate instructions in a random access portion of memory 408 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 408 (e.g., from a read only memory (ROM)) or from the central determination gaming system server 106 to memory 408.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g. amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 286b. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

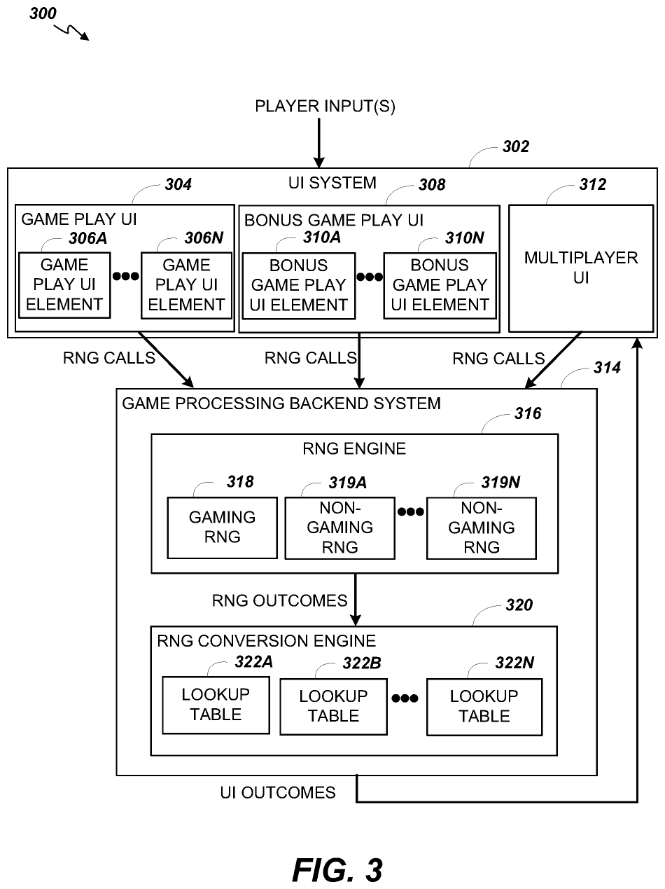

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

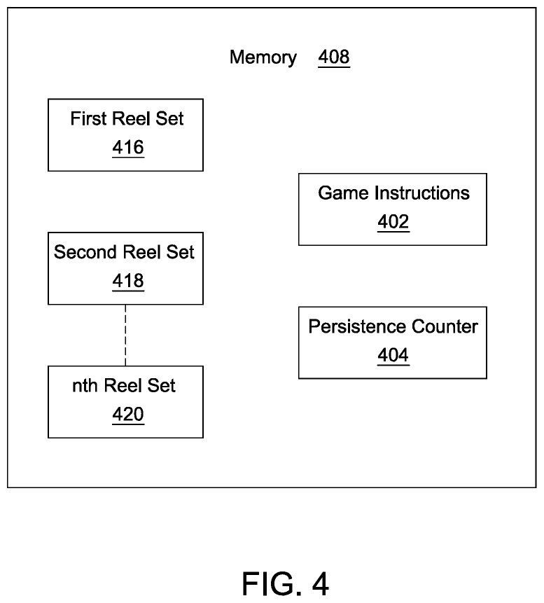

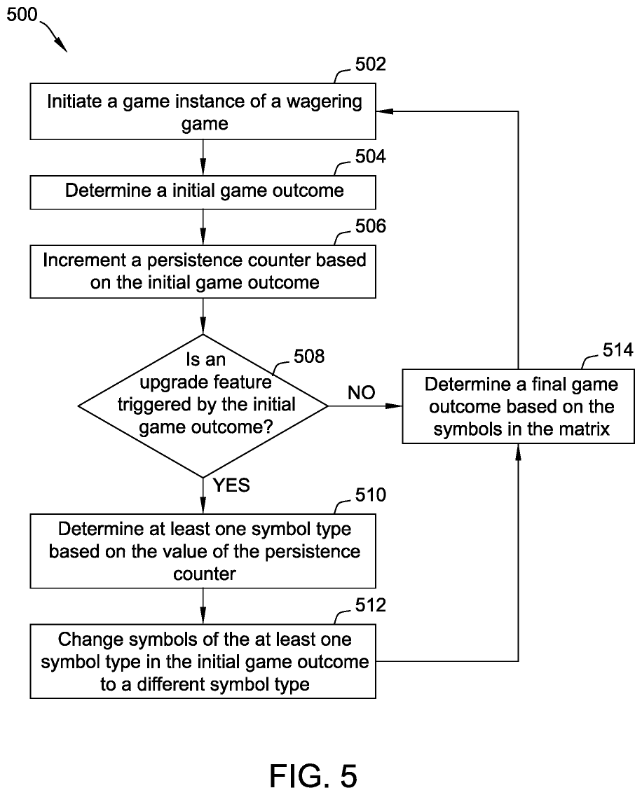

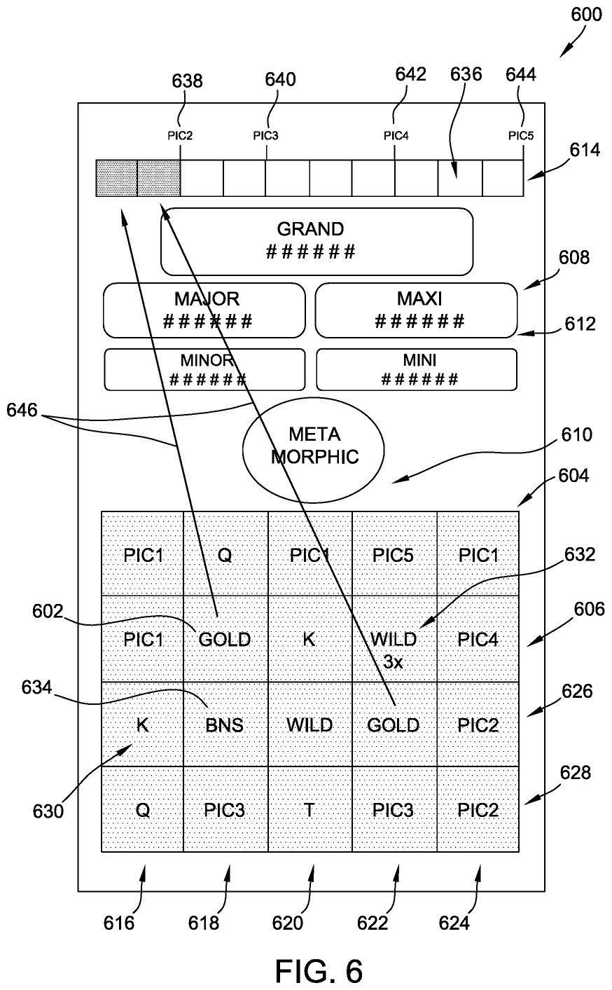

FIG. 4 is a schematic diagram showing the memory 408 of a gaming device for executing an example game display. In the example embodiment, the game is displayed by mobile gaming devices 256, though in an alternative embodiment the game may be displayed on a gaming device similar to gaming devices 104A-104X, shown in FIG. 1. FIG. 5 is a flow chart of an exemplary process 500 for executing electronic play of the game using the memory 408 shown in FIG. 4. FIG. 6 is a schematic of an example game display 600 showing display of the game according to the process 500 of FIG. 5.

Referring to FIG. 4, the memory 408 stores game instructions 402, a persistence counter 404, and a plurality of reel sets 416-420 thereon. Referring to FIG. 6, in the example embodiment, the game displayed according to game instructions 402 is an electronic slot game in which a plurality of symbol positions are displayed to a user (e.g., in the matrix 606 shown in FIG. 6) and are randomly populated with a plurality of symbols (e.g., based on an RNG outcome). The processor 204 continues play of the game based on the set of instructions stored in the memory 408.

The game further utilizes an upgrade feature, also referred to herein as a “bonus” or “bonus feature”, in which one or more of the symbols may be upgraded to change (e.g., increase or decrease) the value of a game outcome. In one example described herein, the persistence counter 404 is used to track the occurrence of scatter symbols 602 in outcomes of the game. During play of the upgrade feature, certain types of symbols in the game outcomes are changed to a different symbol value type. The number of symbol types that are changed is based on the number of collected scatter symbols 602 recorded by the persistence counter 404 during the play of the base game, as described in greater detail below.

Referring to FIG. 5, at a first step 502 in the process 500, a request is received to initiate a game instance. The request includes a first wager value, representing an amount a player is betting on the game instance.

In response, at a second step 504, the processor 204 determines an initial game outcome. The initial game outcome includes a first plurality of symbols displayed in a plurality of columns. The processor 204 determines the initial game outcome by selecting one of the plurality of reel sets 416-420 (shown in FIG. 4) and using one or more RNG outputs to determine stopping positions of reels on the reel sets 416-420. For example, for a first game instance where the persistence counter 404 is equal to zero, the processor 204 selects symbols from the first reel set 416 using the one or more RNG outputs.

The processor 204 further causes the initial game outcome to be displayed, as shown in FIG. 6. FIG. 6 shows an initial outcome of a first game instance of the game. Game display 600 includes a primary play area 604 including a base matrix 606 for displaying a plurality of symbols therein. Game display 600 further includes a secondary play area 608 positioned above the primary play area 604 on the game display 600. The secondary play area 608 includes a metamorphic indicator 610, a plurality of jackpot tiers 612, and a persistence meter 614.

The matrix 606 includes a plurality of columns 616, 618, 620, 622, 624 each including four rows. Processor 204 randomly populates the matrix 606 using reels of the first reel set 416 to fill each one of the symbol positions 626 of the matrix 606 with a symbol, as shown in FIG. 6. The reel set 416 includes at least one reel that corresponds to each column 616, 618, 620, 622, 624. Based on the stopping positions, the processor 204 assigns symbols from the reel set 416 into a corresponding one of the symbol positions 626 of the matrix 606.

In the example embodiment, the symbols include a picture class of symbols 628, a card deck class of symbols 630, and a “WILD” class of symbols 632, such as the “WILD 3X” symbol shown in FIG. 6. The symbols on the reels further include the scatter symbols 602 and upgrade symbols 634 (collectively referred to herein as “feature symbols”). In the example of FIG. 6, the scatter symbols 602 are indicated as “GOLD”. In particular, the scatter symbols 602 appear in the matrix as the “PIC1” symbol, with a gold coloring to differentiate the scatter symbols 602 from the PIC1 symbols. The upgrade symbols 634 are indicated as “BNS” in FIG. 6.

The persistence meter 614 displays a present value of the persistence counter 404. The persistence meter 614 includes a plurality of blocks 636 and threshold indicators 638, 640, 642, 644 positioned between some of the blocks 636. The blocks 636 are filled in to indicate a current state of the persistence counter 404.

Referring back to FIGS. 4 and 5, at step 506 the processor 204 increments the persistence counter 404 based on the initial outcome. In the example, the persistence counter 404 is incremented for each scatter symbol 602 present in the matrix 606 for the initial game outcome. Referring to FIG. 6, the incrementing of the persistence counter 404 is shown visually by a movement of at least a portion or characteristic (e.g., a gold coloring) of the scatter symbols 602 along the direction arrows 646 to one of the blocks 636 of the persistence meter 614. In the example of FIG. 6, two scatter symbols 602 are present in the initial outcome and two corresponding blocks 636 of the persistence meter 614 are filled in.

Referring back to FIG. 5, at step 508, the processor 204 determines whether an upgrade feature is triggered by the initial game outcome. Referring to FIG. 6, in the example, the upgrade feature is triggered based on either one of: i) the persistence counter 404 reaching an overall threshold; and ii) two or more of the upgrade symbols 634 being present in the initial game outcome. In the example of FIG. 6, the threshold for the persistence counter 404 is 10, corresponding to each of the blocks 636 in the persistence meter 614 being filled. Since neither of the two conditions for triggering the upgrade feature are met in that the persistence counter 614 is below the overall threshold and only one upgrade symbol 634 is present in the outcome, processor 204 determines that the upgrade feature is not triggered.

At step 514, shown in FIG. 5, in response to determining that the upgrade feature is not triggered, the processor 204 evaluates the symbols to determine the final game outcome.

In the example embodiment, the symbols are evaluated for winning combinations in the matrix 606 under a “ways” evaluation to determine any credit awards from the game outcome. Each of the columns 616, 618, 620, 622, 624 are analyzed to determine whether any one of the symbols is present in at least one row of each of the first three columns 616, 618, 620 (i.e., irrespective of which row the symbol is positioned in). The picture class of symbols 628 include, in order of highest value to lowest value, “PIC1”, “PIC2”, “PIC3”, “PIC4”, and “PIC5” symbols. The card deck class of symbols 630 include, in order of highest value to lowest value, “A” or “Ace”, “K” or “King”, “Q” or “Queen”, “J” or “JACK”, and “T” or “TEN symbols. If there is a symbol present in at least one row of each of the first three columns, the number of occurrences of the symbol that is present in at least one row of each consecutive column are added up for each column and the added totals are multiplied.

In the example, the scatter symbols 602 are each evaluated as a “PIC1” symbol for determining any awards. The “WILD” symbols evaluate as any symbol which would result in a winning combination. In the example of FIG. 6, none of the symbols are present in at least one row of each of the first three columns 616, 618, 620 and thus no winning combinations are in the outcome. In other embodiments, other methods of evaluating the symbols, such as by using one or more pay lines (not shown), may be used.

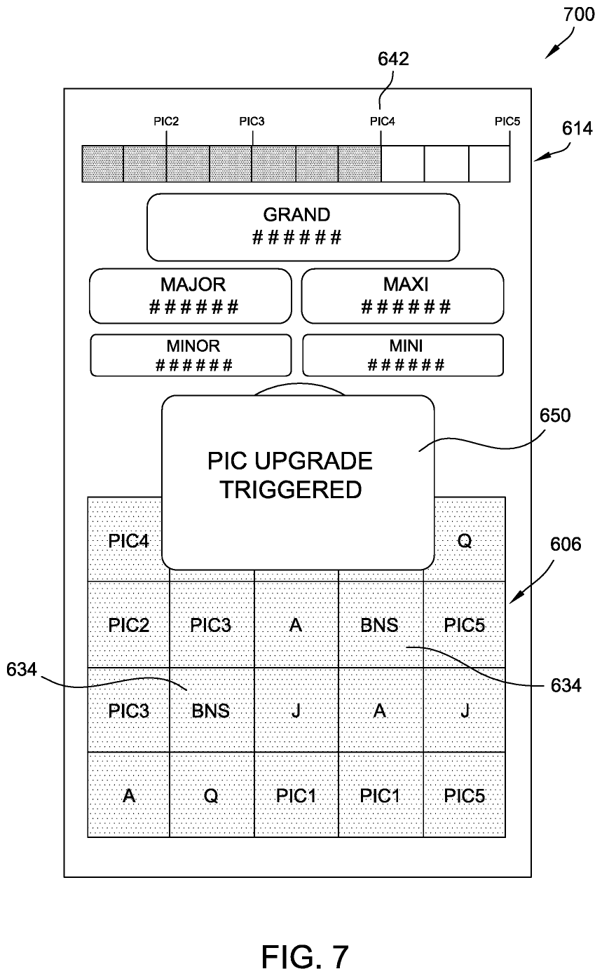

FIG. 7 shows a schematic showing a game display 700 for an initial game outcome of another game instance in which the upgrade feature is triggered. In the example, the upgrade feature is determined to be triggered based on the two upgrade symbols 634 appearing in the initial game outcome. Referring back to FIG. 5, in response to the upgrade feature being triggered, at step 510, processor 204 determines at least one symbol type based on the value of the persistence counter 404.

Referring back to FIG. 7, the persistence meter 614 has a value of seven, equal to the third threshold 642 of “PIC4”, as indicated by the persistence meter 614. Processor 204 determines that the at least one symbol type includes each of the “PIC2”, “PIC3”, and “PIC4” symbols. In the example embodiment, a pop-up message 650 is presented on the display 600 indicating to a player that the upgrade has been triggered.

In some embodiments, the processor 204 may change one or more symbols of the initial game outcome, prior to displaying the initial game outcome on the triggering spin. For example, where the upgrade feature is triggered by the persistence meter 614 being filled to ten in the example, extra scatter symbols 602 in the initial outcome that are in excess of what is needed to meet the threshold may reduce player excitement. Referring to FIG. 7, if four scatter symbols 602 (shown in FIG. 6) were in the outcome to trigger the upgrade feature, instead of the two upgrade symbols 634 shown, processor 204 would change one of the scatter symbols 602 to a different symbol, such as one of the “PIC2”, “PIC3”, “PIC4”, or “PIC5” symbols for the display of the initial game outcome. That is, only two scatter symbols 602 would be displayed in the initial game outcome and the third scatter symbol 602 in the matrix 606 would be changed to a different symbol from the scatter symbols 602. When the upgrade feature is triggered, the extra symbol would then changed back to a “PIC1”, showing the upgrade, for the upgraded game outcome.

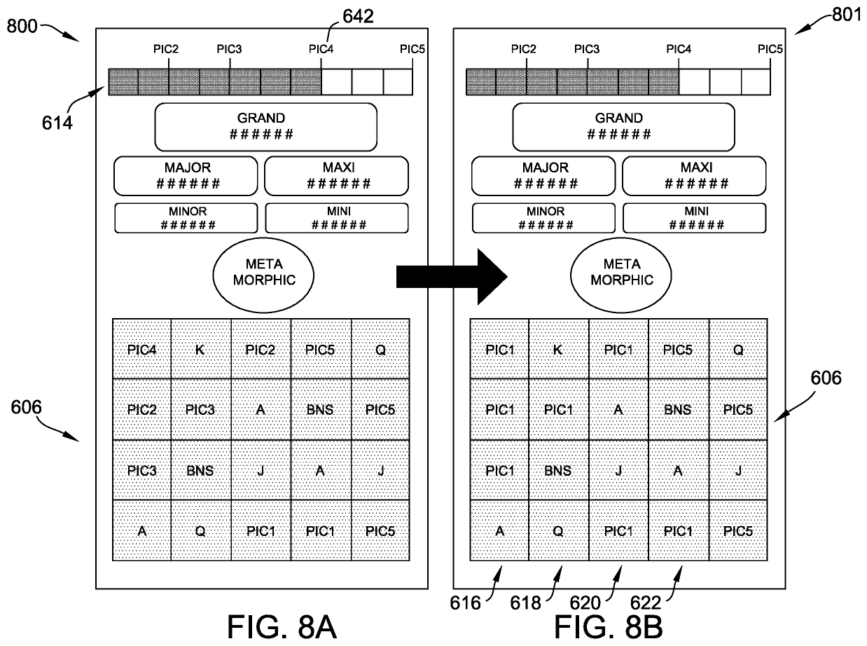

At step 512 (shown in FIG. 5), processor 204 changes symbols of the at least one symbol type in the initial game outcome to a different symbol type. FIG. 8A shows the display 800 at a first moment of the game instance of FIG. 7, prior to the symbol types being changed. FIG. 8B shows the display 801 at a second moment of the game instance of FIG. 7, where the symbol types are changed. Each of the “PIC2”, “PIC3”, and “PIC4” symbols in the matrix 606 of FIG. 8A are changed to “PIC1” symbols in FIG. 8B, as the persistence meter 614 is filled up to the “PIC4” threshold.

Referring back to FIG. 5, after the determined symbol types are changed, the final game outcome for the game instance is determined at step 514. As used herein, the phrase “upgraded game outcome” means any game outcome where the upgrade feature is triggered or the game outcome is otherwise changed from the initial game outcome. In other words, where the upgrade feature is not triggered, as in FIG. 6, the final game outcome is the same as the initial game outcome, as the outcome is unchanged. In contrast, where the symbols are changed, as shown in FIGS. 8A and 8B, the final outcome is upgraded from the initial game outcome. In the example embodiment, the initial game outcomes are displayed to the user, at least in part, to generate player excitement by conveying the increased payouts resulting from the upgrade feature being triggered.

Referring to FIG. 8B, in the example embodiment, after the symbols have been changed, the evaluation determines that there is at least one “PIC1” symbols in at least one row of each of the first four columns 616, 618, 620, 622 and a “ways” award of the combination of seven PIC1 symbols is awarded to the player. As a result, the upgrade feature increases the chances and the amounts of awards to the player. In the example embodiment, the upgrade feature is applied to the “triggering spin”, i.e., the game instance on which the initial outcome triggers the upgrade feature. In other embodiments, the upgrade feature may not be applied to the triggering spin but may be applied on a subsequent spin of the game.

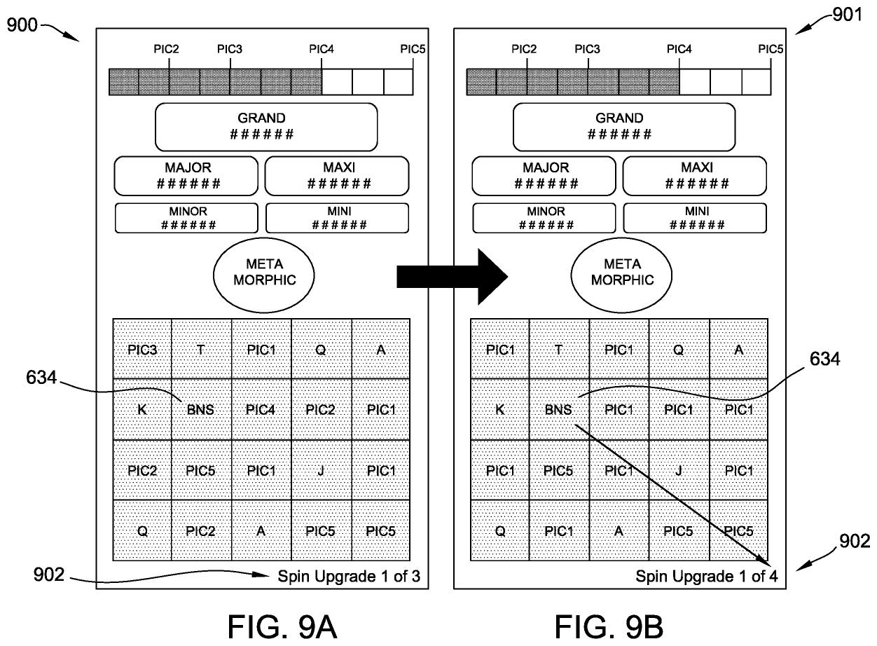

FIG. 9A and FIG. 9B show a display 900 of an initial game outcome and a display 901 of an upgraded game outcome for another game instance following the game instance shown in FIGS. 8A and 8B. In the example embodiment, the upgrade feature continues for a next three paid spins (i.e., plays of the game that require a wager from the player), though in other embodiments the upgrade feature may continue for any other suitable number of additional spins or may last for only the spin on which it is triggered. As shown in FIG. 9A, an upgrade indicator 902 is displayed indicating that the current game instance is “Spin Upgrade 1 of 3.”

In the example embodiment, the upgrade symbols 634, when occurring in the outcomes of the upgrade feature, also trigger an increase in the number of spins the upgrade feature will last for. For example, referring to FIG. 9B, the upgrade indicator 902 increases the total number of upgraded spins from 3 in FIG. 9A to 4 in FIG. 9B, in response to the upgrade symbol 634 being present in the initial outcome. Although not shown in the outcomes of FIGS. 9A and 9B, the scatter symbols 602 continue to increment the persistence counter 404 during the upgraded feature, to potentially unlock different symbols for conversion. For example, in the example of FIG. 9A, if three scatter symbols 602 were in the initial outcome, the scatter symbols 602 (shown in FIG. 6) would increment the persistence counter 404 to a value of 10, thereby unlocking the “PIC. 5” symbol to also be converted to the PIC1 symbol for the final outcomes of the remaining spins of the upgrade features.

In some embodiments, different reel sets 416-420 are selected for use based on whether the upgrade feature is activated or not. For example, the reel sets 416-420 may include at least one first reel set 416 used during the base game and at least one second reel set 418 that is used during the upgrade game. The upgrade game reel sets include different distributions of symbols thereon from the base game reel sets. For example, in some embodiments, the upgrade reel sets 418 include a smaller number of the upgrade symbols 634, since the upgrade symbols 634 are not as valuable in the upgrade game as the upgrade game is already triggered.

In some embodiments, the memory 408 stores any number of different reel sets 416-420 for the base game and upgrade feature and the reel sets 416-420 are selected based on the value of the persistence counter 404. As an example, in the upgrade feature, a different reel set may be used when the upgrade feature is triggered with the persistence counter 404 up to the “PIC3” symbol threshold, as compared to when persistence counter 404 is up to the “PIC4” threshold, that includes fewer “PIC4” symbols. In such embodiments, the symbols are distributed on the reels to adjust or partially compensate for the decreased number of symbols in the outcomes that are eligible to be converted.

After the number of game instances of the upgraded feature are played, the upgraded feature is ended. The persistence counter 404 is reset to zero and all blocks 636 of the persistence meter 614 are cleared. The game is thereby reset and the player continues with playing instances of the base game, collecting scatter symbols 602 in the persistence counter 404 until the upgrade feature is again triggered.

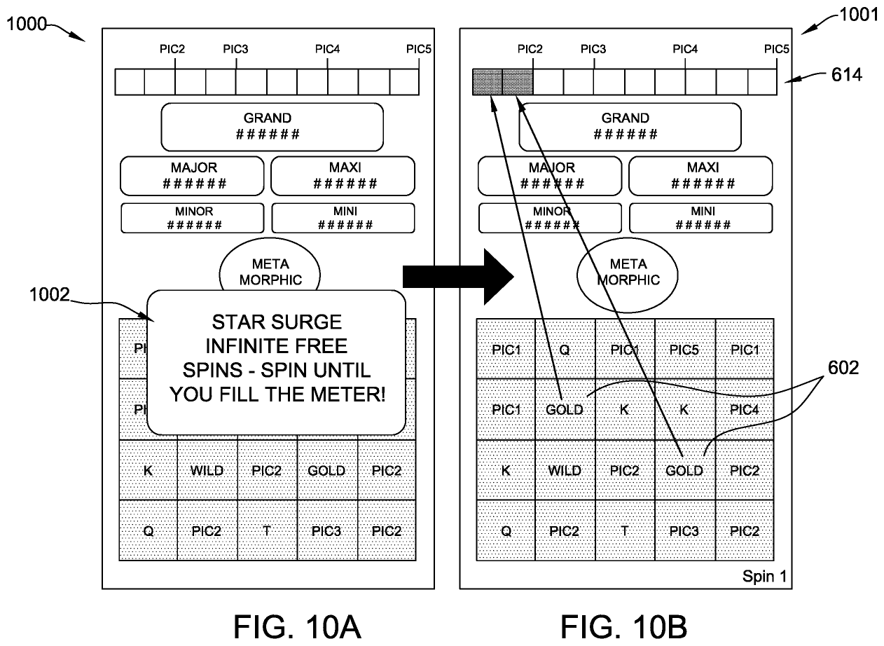

FIGS. 10A-13B show an embodiment of an alternative upgrade feature. The upgrade feature is similar to the feature described with respect to FIGS. 6-9B, except as otherwise described differently herein. In particular, in the example embodiment, the upgrade feature is a free spins feature, whereby a wager is not required for initiating spins of the game while the feature is activated. Additionally, in the alternative upgrade feature, the persistence counter 404 is incremented only during the upgrade feature and the upgrade feature lasts until the persistence counter 404 is filled. The alternative upgrade feature described with respect to FIGS. 10A-13B is referred to herein as an “unlimited” or “infinite” free spins feature.

In the example, the infinite free spins feature is triggered by a purchase for money credits, in which the player selects an option to play the feature and the feature is initiated in response to the player providing a fixed credit amount. Alternatively, the infinite free spins feature may be triggered by a purchase for a secondary currency, such as tokens, loyalty promotions/credits, or other suitable non-monetary currencies. In another embodiment, the infinite free spins feature is triggered based on a random game outcome, such as a special symbol or combination of symbols occurring in the outcome.

Referring to FIG. 10A a game display 1000 showing a triggering of the alternative upgrade feature is shown. After the upgrade feature is triggered, a graphic indicator 1002 is displayed indicating that the infinite free spins feature is activated.

Referring to FIG. 10B, the game display 1001 shows a first spin of the infinite free spins feature. In the example, the persistence meter 614 is set at zero for the first spin of the feature. Similar to the embodiment of FIGS. 6-9B, in the example, the persistence counter 404 is incremented and the persistence meter 614 is correspondingly filled in response to scatter symbols 602 being present in the initial game outcomes. Thus, in FIG. 10B, two blocks 636 are filled in in response to the two scatter symbols 602 in the initial game outcome.

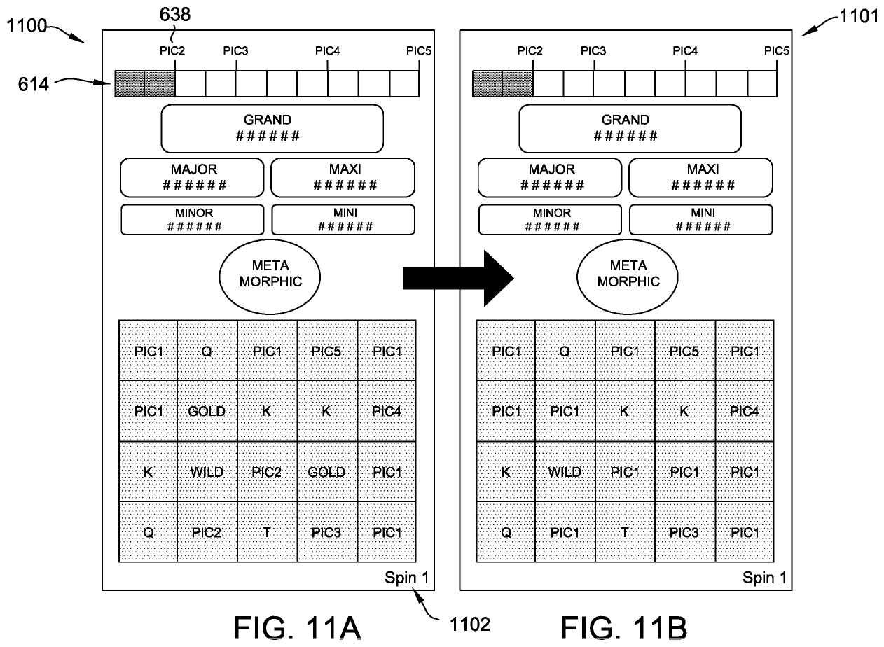

Referring to FIGS. 11A and 11B, with the feature triggered, a spin counter 1102 is added indicating a number of spins that have occurred in the infinite free spins game. In FIG. 11A, showing a game display 1100 of an initial outcome of the game, since the “PIC2” threshold 638 of two symbols is reached, as shown in the persistence meter 614 the “PIC2” symbols present in the initial outcome are changed to “PIC1” symbols for the final outcome of the first spin, as shown in the game display 1101 of FIG. 11B. The player then continues to play additional spins, without any wager being required, collecting scatter symbols 602 incrementing the persistence counter 404 until the persistence counter 404 reaches the threshold (e.g., ten in the example embodiment).

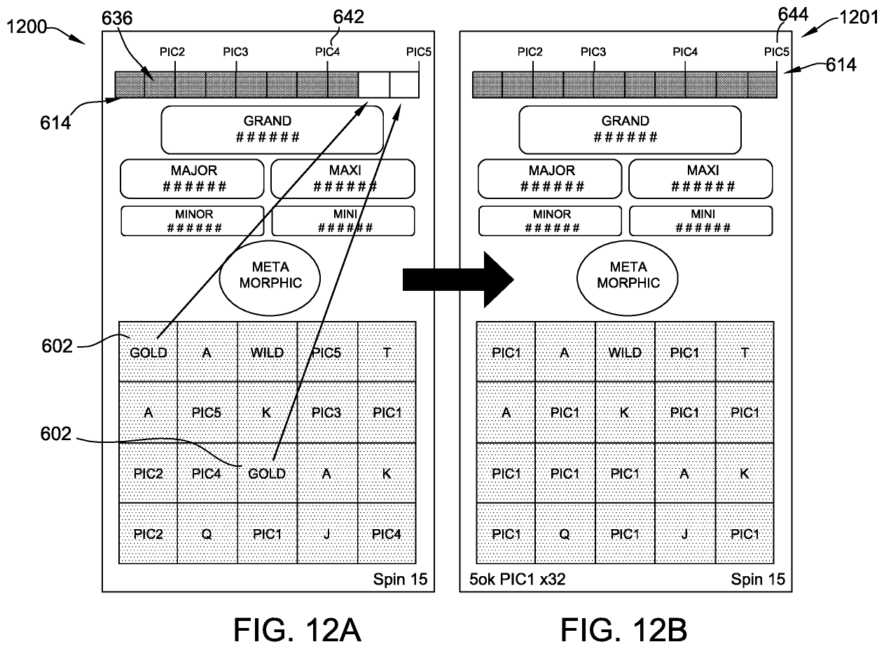

FIGS. 12A and 12B show a fifteenth spin of the infinite free games upgrade feature. Referring to FIG. 12A, showing a game display 1200 of the initial outcome, the persistence meter 614 shows that 8/10 blocks 636 are filled in. In the initial outcome of the spin, two scatter symbols 602 are present. The scatter symbols 602 cause the persistence meter 614 to increment to 10 (i.e., the overall threshold for the persistence counter 404). When the persistence counter 614 reaches the threshold 644, the initial outcome is changed, changing all PIC2-5 symbols to “PIC1” symbols to generate the final outcome, shown in the game display 1201 of FIG. 12B.

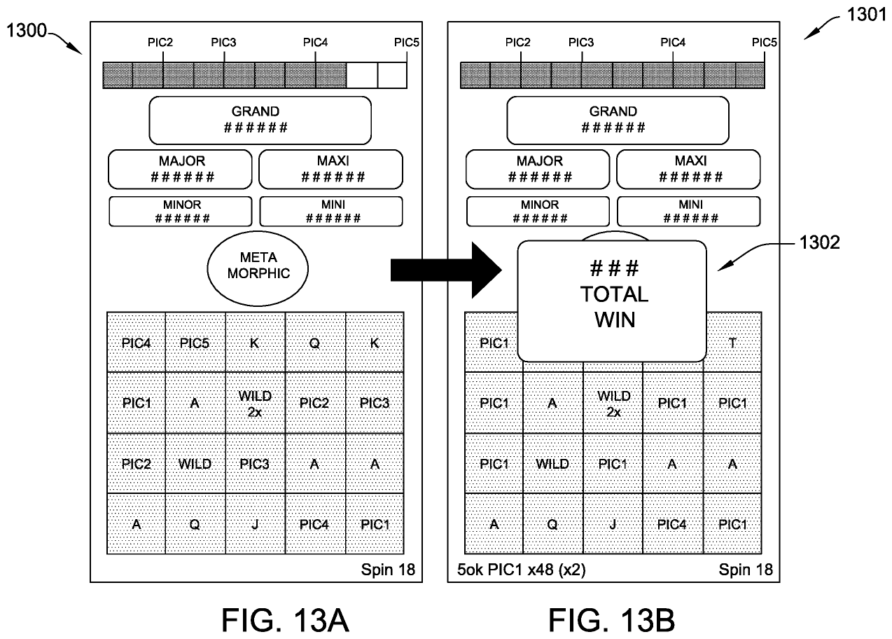

FIGS. 13A and 13B. show an eighteenth spin of the free spins feature. In the example embodiment, after the persistence threshold is reached, a countdown is activated, such that the upgrade feature continues for a predetermined number of final spins, after which the upgrade feature ends. In the example embodiment, the feature continues for three spins, though in other embodiments the upgrade feature may continue for any number of additional final spins. In some embodiments, the feature game is ended after the persistence counter 404 reaches the threshold. During each of these three spins, all PIC2-5 symbols will change to a “PIC1” symbol for the final outcome.

On the last spin, the symbols of the initial outcome, as shown in the game display 1300, are changed for the final outcome, as shown in the game display 1301. Additionally, in the final outcome a pop-up message 1302 is displayed showing a total credit value won during the play of the free spins upgrade feature. Additionally, the persistence counter 404 is reset to zero and the game returns to the base game.

In some embodiments, the memory 408 stores a plurality of different reel sets 416-420 for the free spins upgrade feature that may be selected and used for a given spin depending upon a state of the free spins upgrade. For example, in one embodiment, each reel set of the different reel sets is associated with a range or a given number of spins. As the number of spins change, the reel sets used for the spins may also change. In one example, the reel sets associated with higher spin numbers may include a higher distribution of scatter symbols 602.

In some embodiments, the persistence features described herein are linked to a player account. For example, in mobile or internet gaming embodiments, prior to initiating game play, the player may be prompted to login to their account, which may be associated with a current game and stage counts from a last played session by the player. In casino gaming embodiments, a player tracking card, e.g., associated with a casino player tracking account, or other suitable method of tracking a player identity may be used. In such embodiments, the persistence counter values may be linked to the player account, such that the player may pause play of the game and return at a later point, with the same persistence values in the game as when they had left it. In some embodiments, the persistence features described herein are associated with a given wager and may reset based on a changed wager for a given spin. For example, the memory 408 may store different persistence counters associated with different player wagers. In such embodiments, a player changing their wager for a given spin may prompt an error/warning message and/or change a state of the game to use the persistence counter 404 associated with the changed player wager.

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

This written description uses examples to describe the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A gaming system comprising:
a processor; and
a memory storing instructions and a persistence counter, wherein the instructions when executed by the processor, cause the processor to:
cause display of an initial game outcome by displaying symbols from a plurality of reels in a plurality of columns, the plurality of reels including a plurality of symbol types;
increment the persistence counter based on the initial game outcome;
determine, based on a value of the persistence counter, at least one symbol type of the plurality of symbol types;
change the at least one symbol type in the initial game outcome to a second symbol type; and
determine, based on changing the at least one symbol type, an upgraded game outcome.

2. The gaming system of claim 1, wherein changing the at least one symbol type in the initial game outcome includes changing each symbol of the at least one symbol type in the initial game outcome to the second symbol type.

3. The gaming system of claim 1, wherein the instructions, when executed by the processor, further cause the processor to trigger an upgrade feature of the game based on the initial game outcome, wherein changing the at least one symbol type is in response to the upgrade feature being triggered.

4. The gaming system of claim 3, wherein the upgrade feature is triggered based on the persistence counter reaching a threshold value.

5. The gaming system of claim 3, wherein the upgrade feature is triggered based on an upgrade symbol being present in the initial game outcome.

6. The gaming system of claim 3, wherein the upgraded game outcome is for a first instance of the game, and wherein the upgrade feature persists for a plurality of game instances after the first game instance.

7. The gaming system of claim 6, wherein the plurality of game instances is based on a predetermined number stored on the memory, and wherein the plurality of game instances for the upgrade feature is increased in response to the occurrence of an upgrade symbol in an initial game outcome.

8. The gaming system of claim 3, wherein the memory stores a plurality of reel sets, each reel set of the plurality of reel sets including a plurality of reels, wherein the instructions further cause the processor to:
select a first reel set of the plurality of reel sets based on at least one of the value of the persistence counter and whether the upgrade feature is triggered; and
determine the initial game outcome by mapping the symbols from each reel of the first reel set to the plurality of columns.

9. The gaming system of claim 8, wherein the plurality of reel sets includes a plurality of base reel sets and a plurality of upgrade reel sets, wherein each base reel set and each upgrade reel set are associated with corresponding values of the persistence counter.

10. The gaming system of claim 1, wherein the instructions, when executed by the processor, further cause the processor to determine a number of scatter symbols present in the initial game outcome, wherein the persistence counter is incremented based on the determined number of scatter symbols.

11. The gaming system of claim 1, wherein the at least one symbol type and the second symbol type are different symbol types.

12. The gaming system of claim 1, wherein the instructions, when executed by the processor, further cause the processor to initiate a free spins upgrade feature, and wherein changing the at least one symbol type in the initial game outcome is in response to initiating the free spins upgrade feature.

13. The gaming system of claim 12, wherein the initial outcome is for a first game instance of the free spins upgrade feature, and wherein the persistence counter is incremented in response to at least one scatter symbol occurring in the initial outcome.

14. The gaming system of claim 13, wherein free spins upgrade feature persists for each game instance subsequent to the first game instance, until the persistence counter reaches a threshold, wherein a first number of symbol types are changed when the persistence counter is at a first value and wherein a second number of symbol types greater than the first number of symbol types are changed when the persistence counter is at a second value greater than the first value.

15. A non-transitory computer-readable media containing instructions embodied thereon which, when executed by a processor, cause the processor to:
cause display of an initial game outcome by displaying symbols from a plurality of reels in a plurality of columns, the plurality of reels including a plurality of symbol types;
increment a persistence counter based on the initial game outcome;
determine, based on a value of the persistence counter, at least one symbol type of the plurality of symbol types;
change the at least one symbol type in the initial game outcome to a second symbol type; and
determine, based on changing the at least one symbol type, an upgraded game outcome.

16. The non-transitory computer-readable media of claim 15, wherein changing the at least one symbol type in the initial game outcome includes changing each symbol of the at least one symbol type in the initial game outcome to the second symbol type.

17. The non-transitory computer-readable media of claim 15, wherein the instructions, when executed by the processor, further cause the processor to trigger an upgrade feature of the game based on the initial game outcome, wherein changing the at least one symbol type is in response to the upgrade feature being triggered.

18. The non-transitory computer-readable media of claim 15, wherein the upgraded game outcome is for a first instance of the game, and wherein the upgrade feature persists for a plurality of game instances after the first game instance, wherein the plurality of game instances is based on a predetermined number, and wherein the plurality of game instances for the upgrade feature is increased in response to the occurrence of an upgrade symbol in an initial game outcome.

19. A method of implementing a game comprising:
causing display of an initial game outcome by displaying symbols from a plurality of reels in a plurality of columns, the plurality of reels including a plurality of symbol types;
incrementing a persistence counter based on the initial game outcome;
determining, based on a value of the persistence counter, at least one symbol type of the plurality of symbol types;
changing the at least one symbol type in the initial game outcome to a second symbol type; and
determining, based on changing the at least one symbol type, an upgraded game outcome.

20. The method of claim 19 further comprising triggering an upgrade feature of the game based on the initial game outcome, wherein changing the at least one symbol type is in response to the upgrade feature being triggered.
